(19) United States
(12) Patent Application Publication
(10) Pub. No.: US 2023/0037690 A1
(43) Pub. Date: Feb. 9, 2023

(54) METHOD FOR GENERATING RANDOM NUMBER

(71) Applicant: Korea University Research and Business Foundation, Seoul (KR)

(72) Inventors: Jun Heo, Seoul (KR); Joo Youn Park, Seoul (KR)

(73) Assignee: Korea University Research and Business Foundation, Seoul (KR)

(21) Appl. No.: 17/564,445

(22) Filed: Dec. 29, 2021

(30) Foreign Application Priority Data
Aug. 6, 2021 (KR) 10-2021-0103556

(51) Int. Cl. G06F 7/58

(52) U.S. Cl. CPC G06F 7/588

(57) ABSTRACT

Disclosed is a method for generating a random number, which is performed by a computing device including at least one processor. The method for generating a random number may include: recognizing the number of detection times at which a single photon detector (SPD) detects a dark count; and generating a random number based on a bit value allocated to a section including the number of detection times among a plurality of sections.

### CROSS-REFERENCE TO RELATED APPLICATIONS

This application claims priority to and the benefit of Korean Patent Application No. 10-2021-0103556 filed in the Korean Intellectual Property Office on AUGUST 06, 2021, the entire contents of which are incorporated herein by reference.

### TECHNICAL FIELD

The present disclosure relates to quantum encryption communication, and particularly, to a method for generating a random number by using a dark count phenomenon which occurs inevitably implementing quantum encryption communication.

### BACKGROUND ART

A single photon detector (SPD) used for implementing quantum encryption communication may include a Geiger mode single photon detector which operates only by a control signal and a free running single photon detector which continuously operates without the control signal.

In the quantum encryption communication, a transmitter and a receiver need to generate a random sequence, and in this case, a random number for ensuring complete randomness may be referred to as a true random number, and a quantum random number may be present as one of the types of true random number. Here, the quantum random number may be a random number extracted from a physical system of a pure natural phenomenon other than a person, and generated.

Meanwhile, the single photon detector may be a light detector capable of detecting a photon. As an element that interferes with performance of the single photon detector, a dark count phenomenon may be present. Here, the dark count may be a detected signal generated even when an optical signal is not actually forwarded to the single photon detector, i.e., even though the single photon detector operates in a blackout state. The detected signal generated by the dark count may be generated by shot noise which is not intended by a user.

### SUMMARY OF THE INVENTION

The present disclosure has been made in an effort to provide a method for generating a random number by using a dark count phenomenon.

However, technical objects of the present disclosure are not restricted to the technical object mentioned as above. Other unmentioned technical objects will be apparently appreciated by those skilled in the art by referencing to the following description.

An exemplary embodiment of the present disclosure provides a method for generating a random number, which is performed by a computing device including at least one processor. The method for generating a random number may include: recognizing the number of detection times at which a single photon detector (SPD) detects a dark count; and generating a random number based on a bit value allocated to a section including the number of detection times among a plurality of sections.

The plurality of sections may include a first section and a second section, and a total sum of probabilities that the dark count will be detected as large as each of at least one real value included in the first section may correspond to a total sum of probabilities that the dark count will be detected as large as each of at least one real value included in the second section.

The single photon detector may detect whether the dark count occurs when a trigger signal is applied at a predetermined time interval.

Accordingly, the probability value that the dark count will be detected as large as each real value included in each of the plurality of sections may follow the nominal distribution.

The number of plurality of sections may be determined based on a bit size set by a user.

When the bit size is ^{N}, the number of plurality of sections may be 2^{N} , and the may be a natural number.

A probability that each of the plurality of sections will be generated may be ½^{N}.

Another exemplary embodiment of the present disclosure provides a device for generating a random number, including: a single photon detector (SPD) detecting a dark count; and a processor, in which the processor recognizes that the number of detection times at which the single photon detector may detect the dark count, and generate a random number based on a bit value allocated to a section including the number of detection times among a plurality of sections.

The plurality of sections may include a first section and a second section, and a total sum of probabilities that the dark count will be detected as large as each of at least one real value included in the first section may correspond to a total sum of probabilities that the dark count will be detected as large as each of at least one real value included in the second section.

The single photon detector may detect whether the dark count occurs when a trigger signal is applied at a predetermined time interval.

Accordingly, the probability value that the dark count will be detected as large as each real value included in each of the plurality of sections may follow the nominal distribution.

The number of plurality of sections may be determined based on a bit size set by a user.

When the bit size is ^{N} ^{N}, the number of plurality of sections may be 2^{N} N, and the ^{N} 2^{N} may be a natural number.

Further, a probability that each of the plurality of sections will be generated may be ½^{N}.

Technical solving means which can be obtained in the present disclosure are not limited to the aforementioned solving means and other unmentioned solving means will be clearly understood by those skilled in the art from the following description.

According to some exemplary embodiments of the present disclosure, a method which can generate a quantum random number without consuming a separate device or secret key can be provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 is a block diagram for describing an example of a device for generating a random number according to some exemplary embodiments of the present disclosure.

FIG. 2 is a flowchart for describing an example of a method for generating a random number according to some exemplary embodiments of the present disclosure.

FIG. 3 is a diagram for describing an example of a method for generating a random number according to some exemplary embodiments of the present disclosure.

### DETAILED DESCRIPTION

Various exemplary embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

Although the terms “first” “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

The word “comprises” and/or “comprising” means that the corresponding feature and/or component is present, but it should be appreciated that presence or addition of one or more other features, components, and/or a group thereof is not excluded. Further, when not separately specified or it is not clear in terms of the context that a singular form is indicated, it should be construed that the singular form generally means “one or more” in this specification and the claims.

Further, the terms “information” and “data” used in the specification may also be often used to be exchanged with each other.

It should be understood that, when it is described that a component is “connected to” or “accesses” another component, the component may be directly connected to or access the other component or a third component may be present therebetween. In contrast, it should be understood that, when it is described that a component is “directly connected to” or “directly access” another component, no component is present between the component and another component.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention or a usual practice of a user or an operator.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

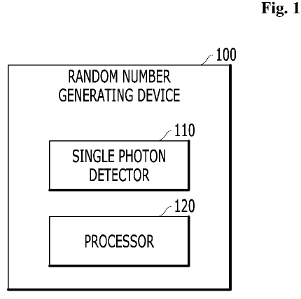

In the present disclosure, a random number generating device may include a single photon detector (SPD). When light is detected by using the single photon detector using an avalanche photodiode, a dark count phenomenon in which a detected signal is output may occur even though the light is not actually input. Here, the avalanche photodiode as a photodiode having an amplification mechanism of optical current therein may be a photodiode generally as a light detector. Meanwhile, as described above, the dark count phenomenon may occur even when an optical signal is not actually forwarded to the single photon detector, i.e., even though the single photon detector is operated in a blackout state. In addition, the dark count phenomenon as a phenomenon which occurs by a kind of noise may be a phenomenon not intended by a user. Accordingly, when a random number is generated by using the number of occurrence times of the dark count phenomenon, the generated random number may be a true random number. Hereinafter, a method for generating a random number according to the present disclosure will be described with reference to FIGS. 1 to 3.

FIG. 1 is a block diagram for describing an example of a device for generating a random number according to some exemplary embodiments of the present disclosure.

Referring to FIG. 1, the random number generating device 100 may include a single photon detector 110 and a processor 120. However, components described above are not required in implementing the random number generating device 100, so the random number generating device 100 may have components more or less than components listed above.

The random number generating device 100 may be a computing device implementing quantum encryption communication. However, the present disclosure is not limited thereto.

The single photon detector 110 is a device capable of detecting a photon, and the single photon detector 110 according to the present disclosure may detect a dark count phenomenon (hereinafter, referred to as a dark count). According to an embodiment, when a trigger signal is applied at a predetermined time interval, the single photon detector 110 may detect whether the dark count occurs. As an example, the single photon detector 110 may apply the trigger signal at the predetermined time interval in a blackout state. In addition, when a detected signal is generated even though the trigger signal is applied in the blackout state, the single photon detector 110 may recognize that the dark count occurs. However, the present disclosure is not limited thereto.

Meanwhile, the processor 120 may generally control an overall operation of the random number generating device 100. The processor 120 processes a signal, data, information, and the like input or output through the components or drives the application program stored in a database (not illustrated) to provide or process information or a function appropriate for the user.

In the present disclosure, when the processor 120 recognizes the number of detection times of the dark count through the single photo detector 110, the processor 120 may generate the random number based on a bit value allocated to a section including the number of detection times among a plurality of sections.

Specifically, a probability P (P is a decimal that the dark count will occur is defined as a natural number) and when m (m is a natural number) trigger signals are applied to the single photon detector 110 at a predetermined time interval, a random variable in which the dark count is detected at a corresponding time may follow a binominal distribution ^{x}, ^{~B(m}ₓ ^{p)}. Here, the trigger signal may be a signal applied to the single photon detector 110 for detection of the photon or detection of the dark count. Further, the corresponding time may be a time when all m trigger signals are applied.

Meanwhile, when m is a sufficiently large number, that is, when the number of ^{X} trigger signals is sufficiently large, ^{X} which is a sum of the random variable ^{x}1 may follow a nominal distribution ^{X~M(mp, mp(1-p)}. Here, ^{x} which is the sum of the random variable ^{x}1 may be derived as in ^{X} =

$$\sum {}_{i = 1}^{m} {x}_{i} .$$

That is, when it is detected whether the dark count occurs as much as a sufficient time, a probability value that the dark count will be detected each number of times may follow the nominal distribution. Meanwhile, in the present disclosure, the processor 120 may generate a plurality of sections by using the number of detection times of the dark count. Here, when it is detected whether the dark count occurs as much as the sufficient time, since the probability value that the dark count will be detected each number of times follows the nominal distribution, the probability value that the dark count will be detected may also follow the nominal distribution as large as each real value included in each of the plurality of sections.

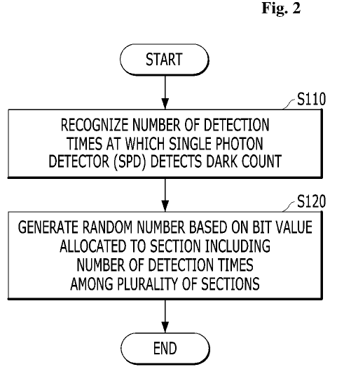

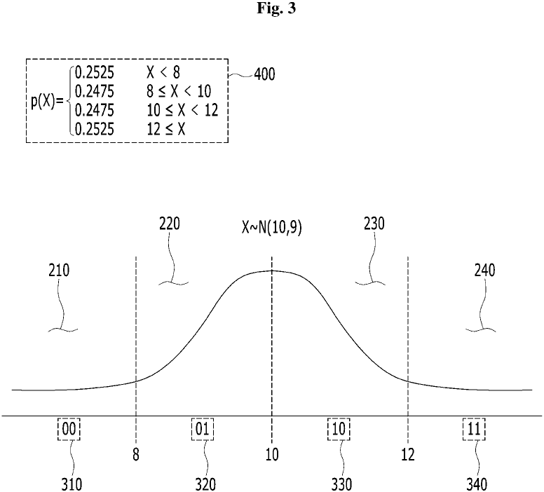

For example, the processor 120 may divide real values of 1 to 7 by a first section, divide real values of 8 and 9 by a second section, divide real values of 10 and 11 by a third section, and divide the remaining real values (12 to 100) by a fourth section. In addition, the real value included in each section may mean the number of occurrence times of the dark count for a sufficient time. Accordingly, the probability value that the dark count will be detected as large as each real value included in each of the plurality of sections may follow the nominal distribution. In addition, when a plurality of sections is divided, the processor 120 may allow the bit value to each of the plurality of sections. In this case, the processor 120 may generate the random number based on the bit value allocated to a section including the number of detection times at which the single photon detector 110 detects to the dark count among the plurality of sections. That is, the processor 120 may generate the random number by using the dark count unintentionally detected by the single photon detector 110. Accordingly, the generated random number may be a true random number. Hereinafter, a method for generating the random number by the processor 120 will be described in more detail with reference to FIGS. 2 and 3.

FIG. 2 is a flowchart for describing an example of a method for generating a random number by a random number generating device according to some exemplary embodiments of the present disclosure. FIG. 3 is a diagram for describing an example of a method for generating a random number according to some exemplary embodiments of the present disclosure.

Referring to FIG. 2, the processor 120 of the random number generating device 100 may recognize the number of detection times at which a single photon detector 110 detects a dark count (S110).

As an example, the processor 120 may apply the trigger signal to the single photon detector 110 in the blackout state at the predetermined time interval. In addition, when the detected signal is generated by the single photon detector 110 even though the trigger signal is applied in the blackout state, the processor 120 may recognize that the dark count occurs. In this case, the processor 120 may recognize the number of times at which the detected signal is generated as the number of detection times at which the dark count is detected. However, the present disclosure is not limited thereto.

Meanwhile, the processor 120 of the random number generating device 100 may generate the random number based on the bit value allocated to the section including the number of detection times among the plurality of sections (S120).

As an example, referring to FIG. 3, when ^{m} is 100 and ^{P} is 0.1, ^{X} may follow a nominal distribution

$$N ( 10 , 9 )$$

. In this case, the processor 120 may generate a plurality of sections including a first section 210 to a fourth section 240. For example, the processor 120 may divide real values of 1 to 7 by the first section 210, divide real values of 8 and 9 by a second section 220, divide real values of 10 and 11 by a third section 230, and divide the remaining real values (12 to 100) by the fourth section 240. In addition, when the plurality of sections is generated, the processor 120 may allow the bit value to each of the plurality of sections. According to an embodiment, the processor 120 may allocate a first bit value 310 to the first section 210 and allocate a second bit value 320 to the second section 220. Further, the processor 120 may allocate a third bit value 330 to the third section 230 and a fourth bit value 340 to the fourth section 240. As a result, when the number of detection times is recognized, the processor 120 may determine a bit value allocated to a section including the number of detection times among the first section 210 to the fourth section 240.

For example, the processor 120 may recognize that the number of detection times at which the single photon detector 110 detects the dark count through m execution times as 6. In this case, the processor 120 may determine, as the first section 210, a section including 6 detection times among the plurality of sections. As a result, the processor 120 may recognize the first bit value 310 allocated to the first section 210, and generate the random number based on the first bit value 310. However, the present disclosure is not limited thereto.

According to some exemplary embodiments of the present disclosure, the processor 120 may perform an operation of detecting the dark count ^{k} (^{k} is a natural number) times through ^{m} execution times. In this case, the processor may generate the random number based on a bit value determined while performing ^{k} operations. As an example, when ^{k} is 3, the processor 120 may determine the first bit value 310 based on the number of detection times at which the single photon detector 110 detects the dark count through first ^{m} execution times. In addition, the processor 120 may determine the second bit value 320 based on the number of detection times at which the single photon detector 110 detects the dark count through second ^{m} execution times. Further, the processor 120 may determine the first bit value 310 based on the number of detection times at which the single photon detector 110 detects the dark count through third ^{m} execution times. In this case, the processor 120 may generate a random number such as “000100”. However, the present disclosure is not limited thereto.

Meanwhile, according to some exemplary embodiments of the present disclosure, the plurality of sections may include the first section 210 and the second section 220. In this case, a total sum of probabilities that the dark count will be detected as large as each of at least one real value included in the first section 210 may correspond to a total sum of probabilities that the dark count will be detected as large as each of at least one real value included in the second section 220. According to an embodiment, the plurality of sections may include the first section 210 to the fourth section 240. In this case, the total sums of the probabilities that the dark count will be detected as large as each of at least one real value included in the respective sections may correspond to each other.

Specifically, referring to ^{p(X)} 400 which is a probability distribution of ^{X}, the total sum of the probabilities that the dark count will be detected as large as each of at least one real value included in the first section 210 may be 0.2525. In this case, the total sum of the probabilities that the dark count will be detected as large as each of at least one real value included in the second section 220 may be 0.2475. Further, a total sum of the probabilities that the dark count will be detected as large as each of at least one real value included in the third section 230 may be 0.2475. In addition, a total sum of the probabilities that the dark count will be detected as large as each of at least one real value included in the fourth section 240 may be 0.2525. That is, the total sums of the probabilities that the dark count will be detected as large as each of at least one real value included in the respective sections may correspond to each other. Here, a fact that the total sums of the probabilities that the dark count will be detected may correspond to each other may mean that the total sums may be similar to each other (a difference in total sum is 0.01 or less) or the same as each other. As a case where ^{m} is 100 is described as an example in order to help understand in the above-described example, the total sums of the probabilities that the dark count will be detected in the respective sections may be determined to be similar to each other. However, when ^{m} is a sufficiently large number, the total sums of the probabilities that the dark count will be detected may also be determined to be the same as each other. However, the present disclosure is not limited thereto.

Meanwhile, according to some exemplary embodiments of the present disclosure, the number of plurality of sections may be determined based on a bit size set by the user.

Specifically, the processor 120 may receive the bit size from the user through a user input unit, etc. In this case, the processor 120 may determine the number of plurality of sections based on the bit size set by the user. As an example, when the bit size is ^{N} (^{N} is the natural number), the number of plurality of sections may be 2^{N} .

For example, referring to the first bit value 310, the first bit value 310 may be “00”. Accordingly, a size of the first bit value may be 2. That is, the processor 120 may receive that two bits or a bit having a size of 2 is generated from the user. In this case, the processor 120 may divide the plurality of sections into 4 which is 2² based on the bit size received from the user. However, the present disclosure is not limited thereto.

Meanwhile, according to some exemplary embodiments of the present disclosure, a probability that each of the plurality of sections will be generated may be ½⁸ . As an example, when the processor 120 of the random number generating device 100 receives that two bits are generated from the user, the plurality of sections may be divided so that the probability that each of the plurality of sections will be generated becomes ½⁸ . In this case, the total sums of the probabilities that the dark count will be detected may be the same as each other. However, the present disclosure is not limited thereto.

Meanwhile, according to some exemplary embodiments of the present disclosure, the processor 120 of the random number generating device 100 may also acquire a generation speed of the random number. In this case, the user may also determine whether to perform a task for generating the random number according to the present disclosure by considering the generation speed of the random number.

Specifically, according to an embodiment, when ^{m} is 100 and ^{P} is 0.1, ^{p(X)} 400 which is the probability distribution of ^{X} may be determined as illustrated in FIG. 3. In this case, when the processor 120 allocates a bit to a zone corresponding to a value of ^{X}, two random bits may be obtained during 100 times which is a predetermined number of times. When it is assumed that the processor 120 inputs the trigger signal into the single photon detector 110 at 100 MHz, the number of execution times may be 10⁸ based on 1 seconds. In addition, when each section is considered in units of 100 times which is the predetermined number of times (or interval), 10⁸ sections may be generated. In this case, when two bits are generated in one section, the generation speed of the random number generated by the processor 120 may become 2 MHz.

According to an embodiment, based on a practical performance of the single photon detector 110,

$$p = 1.7 \times {10}^{- 5}$$

may be assumed,

$$n = 5 \times {10}^{- 6}$$

may be assumed, and it may be assumed that an operation speed of the single photon detector 110 is 100 MHz. In this case, the generation speed of the random number generated by the processor 120 may be calculated as 40 b/s. However, this is just an embodiment, and the generation speed of the random number generated by the processor 120 may be determined according to the performance of the single photon detector 110.

Meanwhile, according to some exemplary embodiments of the present disclosure, the generation speed of the random number by the processor 120 of the random number generating device 100 may also be determined based on the section to which the bit is allocated.

Specifically, the processor 120 may determine a probability that each of the plurality of sections will be generated to be ⅛ based on an input from the user. That is, the processor 120 may receive the bit size so as to generate 3 bits for every section from the user. Specifically, the processor 120 may determine a probability that each of the plurality of sections will be generated to be

$$\frac{1}{{2}^{3}}$$

based on the bit size. In addition, when p= 1.7 × 10⁻⁶ is assumed, n=5 × 10⁻⁶ is assumed, and it is assumed that the operation speed of the single photon detector 110 is 100 MHz, the generation speed of the random number generated by the processor 120 may be 60 b/s. However, the present disclosure is not limited thereto.

According to the above-described contents, the random number generating device 100 may generate the random number based on the bit value allocated to a section including the number of detection times at which the single photon detector 110 detects to the dark count among the plurality of sections. That is, the random number generating device 100 may generate the random number by using the dark count unintentionally detected by the single photon detector 110. Accordingly, the generated random number may be the true random number, and when the quantum encryption communication is performed by using the random number, safe communication may be possible.

The random number used in the conventional quantum encryption communication may be made by a separately prepared quantum random number generator or a method for using some random secret keys generated by the quantum communication. In this case, since the separate quantum random number generator is required or some secret keys should be consumed, there may be a problem in that a key generation rate may decrease.

On the contrary, according to the above-described contents, since a separate device is not required, cost may be reduced, and as some secret keys are not used, the key generation rate increases, safer communication may be possible. Specifically, the reason why the safer communication is possible when the key generation rate increases is that the key generation rate decreases as an encryption communication distance increases, and if the key generation rate becomes higher, an encryption key may be sent and received further. Accordingly, when the random number generating device 100 according to the present disclosure is utilized, even safer communication may be possible.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for generating a random number, which is performed by a computing device including at least one processor, the method comprising:
recognizing the number of detection times at which a single photon detector (SPD) detects a dark count; and
generating a random number based on a bit value allocated to a section including the number of detection times among a plurality of sections.

2. The method of claim 1, wherein the plurality of sections includes a first section and a second section, and
a total sum of probabilities that the dark count will be detected by each of at least one real value included in the first section corresponds to a total sum of probabilities that the dark count will be detected by each of at least one real value included in the second section.

3. The method of claim 1, wherein the single photon detector detects whether the dark count occurs when a trigger signal is applied at a predetermined time interval.

4. The method of claim 1, wherein a probability value that the dark count will be detected by each real value included in each of the plurality of sections follows a nominal distribution.

5. The method of claim 1, wherein the number of the plurality of sections is determined based on a bit size set by a user.

6. The method of claim 5, wherein when the bit size is ^{N}, the number of the plurality of sections is 2ⁿ, and
the Nis a natural number.

7. The method of claim 6, wherein a probability that each of the plurality of sections will be generated is ¹/2^{N}_{.}

8. A device for generating a random number, the device comprising:
a single photon detector (SPD) detecting a dark count; and
a processor,
wherein the processor
recognizes that the number of detection times at which the single photon detector detects the dark count, and
generates a random number based on a bit value allocated to a section including the number of detection times among a plurality of sections.

9. The device of claim 8, wherein the plurality of sections includes a first section and a second section, and
a total sum of probabilities that the dark count will be detected by each of at least one real value included in the first section corresponds to a total sum of probabilities that the dark count will be detected by each of at least one real value included in the second section.

10. The device of claim 8, wherein the single photon detector detects whether the dark count occurs when a trigger signal is applied at a predetermined time interval.

11. The device of claim 8, wherein a probability value that the dark count will be detected by each real value included in each of the plurality of sections follows a nominal distribution.

12. The device of claim 8, wherein the number of the plurality of sections is determined based on a bit size set by a user.

13. The device of claim 12, wherein when the bit size is ^{N}, the number of the plurality of sections is 2 ^{N}, and
the Nis a natural number.

14. The device of claim 13, wherein a probability that each of the plurality of sections will be generated is ½^{N}_{.}
